(19) United States
(12) Patent Application Publication
(10) Pub. No.: US 2026/0351165 A1
(43) Pub. Date: Nov. 5, 2026

(54) LIGHT EMITTING DISPLAY APPARATUS

(71) Applicant: LG Display Co., Ltd., Seoul (KR)

(72) Inventor: Yongmin JEONG, Paju-si (KR)

(73) Assignee: LG Display Co., Ltd., Seoul (KR)

(21) Appl. No.: 19/651,275

(22) Filed: Apr. 17, 2026

(30) Foreign Application Priority Data
Apr. 30, 2025 (KR) 10-2025-0057300

(51) Int. Cl. G09G 3/32; G09G 3/20

(52) U.S. Cl. CPC G09G 3/32; G09G 3/2007; G09G 2300/0426; G09G 2300/0819; G09G 2300/0852; G09G 2300/0861; G09G 2310/08; G09G 2330/021; G09G 2360/144

(57) ABSTRACT

A light emitting display apparatus includes a light emitting device and a pixel driving circuit connected to the light emitting device and configured to drive the light emitting device. The pixel driving circuit includes a control node circuit unit including a control node having a voltage that is set based on a data voltage and a slope voltage, a PWM circuit unit including a control transistor configured to adjust a light emission time of the light emitting device according to the voltage of the control node, and a driving circuit unit including a driving transistor configured to be turned on by the control transistor and to control a current flowing through the light emitting device. The control node circuit unit includes a first transistor and a first coupling capacitor configured to supply the data voltage and the slope voltage to the control node.

### CROSS-REFERENCE TO RELATED APPLICATIONS

This application claims the benefit of and priority to Korean Patent Application No. 10-2025-0057300 filed in Republic of Korea on Apr. 30, 2025, the entirety of which is incorporated herein by reference for all purposes.

### BACKGROUND

### Technical Field

The present disclosure relates to a light emitting display apparatus.

### Description of the Related Art

With the development of information society, the demand for a display apparatus for displaying an image is increasing in various forms. Accordingly, display apparatuses such as a liquid crystal display (LCD) apparatus, an organic light emitting display (OLED) apparatus, a micro light emitting diode LED display apparatus, a quantum dot display (QD) apparatus, and the like are used.

A general light emitting display apparatus uses, in order to express gradation, a PAM (Pulse Amplitude Modulation) method for adjusting an amount of current flowing through a light emitting device, a PWM (Pulse Width Modulation) method for fixing a current value and adjusting a light emission time, or a driving method in which the PAM method and the PWM method are combined.

### BRIEF SUMMARY

Among the light emitting display apparatuses, the micro light emitting diode display apparatus is an apparatus for displaying an image by including, as subpixels, ultra small micro light emitting diodes emitting red, green, and blue. The micro light emitting diode display apparatus has an advantage in that a display apparatus having low power consumption, miniaturization, and reduced weight may be implemented through a miniaturized structure and low power consumption characteristics.

However, since a micro light emitting diode has a characteristic in which an emission wavelength varies according to an amount of current, when gradation is expressed by the PAM driving method, wavelength shift occurs, and thus there has been a problem in that screen distortion caused by a color change occurs during a pixel driving process.

The micro light emitting diode display apparatus may include a compensation circuit using a PWM driving method in order to prevent screen distortion caused by a color change. However, since such a compensation circuit has a complicated circuit configuration for adjusting a light emission time and fixing a current value, there is a problem in that parameter sizes of circuit elements increase and the number of control signals increases.

One or more embodiments of the present disclosure may provide a light emitting display apparatus capable of implementing PWM driving without a complicated control circuit through stable control of a control node by a data voltage.

One or more embodiments of the present disclosure may provide a light emitting display apparatus capable of reducing parameter sizes of circuit elements and the number of control signals by configuring a simplified PWM driving circuit.

One or more embodiments of the present disclosure may provide a light emitting display apparatus capable of implementing PWM driving enabling real time luminance control without a separate external circuit by including, in each subpixel, a photosensitive device capable of adjusting a voltage of a control node according to an intensity of external light.

Additional advantages and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

A light emitting display apparatus according to one or more embodiments of the present disclosure may include a light emitting device, and a pixel driving circuit connected to the light emitting device and configured to drive the light emitting device. The pixel driving circuit may include a control node circuit unit including a control node having a voltage that is set based on a data voltage and a slope voltage, a PWM circuit unit including a control transistor configured to adjust a light emission time of the light emitting device according to the voltage of the control node, and a driving circuit unit including a driving transistor configured to be turned on by the control transistor and to control a current flowing through the light emitting device.

Specific details according to various embodiments of the present disclosure are included in the following description and the accompanying drawings.

According to one or more embodiments of the present disclosure, a light emitting display apparatus capable of implementing PWM driving without a complicated control circuit through stable control of a control node by a data voltage may be provided.

According to one or more embodiments of the present disclosure, a light emitting display apparatus capable of reducing parameter sizes of circuit elements and the number of control signals by configuring a simplified PWM driving circuit may be provided.

According to one or more embodiments of the present disclosure, a light emitting display apparatus capable of implementing PWM driving enabling real time luminance control without a separate external circuit by including, in each subpixel, a photosensitive device capable of adjusting the voltage of a control node according to an intensity of external light may be provided.

The light emitting display apparatus according to one or more embodiments of the present disclosure may implement optimized PWM driving without a complicated control circuit or a separate external circuit through stable control of a control node by a data voltage, thereby enabling low power driving by reducing power consumption and reducing parameter sizes of circuit elements and the number of control signals, whereby it is possible to implement Environment/Social/Governance (ESG) by reducing production energy consumption.

The effects of the present disclosure are not limited to the aforesaid, but other effects not described herein will be clearly understood by those skilled in the art from the following descriptions.

The details of the present disclosure described in technical problem, technical solution, and advantageous effects do not specify essential features of claims, and thus, the scope of claims is not limited by the details described in detailed description of the disclosure.

### BRIEF DESCRIPTION OF THE SEVERAL VIEWS OF THE DRAWINGS

The accompanying drawings, which are included to provide a further understanding of the disclosure, are incorporated in and constitute a part of this disclosure, illustrate aspects and embodiments of the disclosure, and together with the description serve to explain the principles and examples of the disclosure.

FIG. 1 illustrates a light emitting display apparatus according to an embodiment of the present disclosure.

FIG. 2 is a circuit diagram illustrating a pixel driving circuit of a light emitting display apparatus according to an embodiment of the present disclosure.

FIG. 3 illustrates driving timing of a pixel driving circuit according to an embodiment of the present disclosure.

FIG. 4 illustrates an operation state of the pixel driving circuit in a first period shown in FIG. 3 according to an embodiment of the present disclosure.

FIG. 5 illustrates an operation state of the pixel driving circuit in a second period shown in FIG. 3 according to an embodiment of the present disclosure.

FIG. 6 illustrates a pixel structure of a light emitting display apparatus according to another embodiment of the present disclosure.

FIG. 7 is a circuit diagram illustrating a pixel driving circuit of a light emitting display apparatus according to another embodiment of the present disclosure.

FIG. 8 illustrates driving timing of a pixel driving circuit according to another embodiment of the present disclosure.

FIG. 9 illustrates an operation state of the pixel driving circuit in a first period shown in FIG. 8 according to another embodiment of the present disclosure.

FIG. 10 illustrates an operation state of the pixel driving circuit in a second period shown in FIG. 8 according to another embodiment of the present disclosure.

FIG. 11 illustrates a plurality of subpixels in a light emitting display apparatus according to another embodiment of the present disclosure.

FIG. 12 is a cross-sectional view taken along line I-I′ of FIG. 11 according to another embodiment of the present disclosure.

Throughout the drawings and the detailed description, unless otherwise described, the same drawing reference numerals should be understood to refer to the same elements, features, and structures. The sizes, lengths, and thicknesses of layers, regions and elements, and depiction of thereof may be exaggerated for clarity, illustration, and/or convenience.

### DETAILED DESCRIPTION

Advantages and features of the present disclosure, and implementation methods thereof, are clarified through the embodiments described with reference to the accompanying drawings. The present disclosure may, however, be embodied in different forms and should not be construed as limited to the embodiments set forth herein. Rather, these embodiments are examples and are provided so that this disclosure may be thorough and complete, to assist those skilled in the art to understand the inventive concepts without limiting the protected scope of the present disclosure.

Shapes (e.g., lengths, widths, heights, thicknesses, locations, radii, diameters, and areas), sizes, ratios, angles, numbers, and the like disclosed herein, including those illustrated in the drawings are merely examples, and thus, the present disclosure is not limited to the illustrated details. Any implementation described herein as an “example” is not necessarily to be construed as preferred or advantageous over other implementations. It is, however, noted that the relative dimensions of the components illustrated in the drawings are part of the present disclosure.

When the term “comprise,” “have,” “include,” “contain,” “constitute,” “made of,” “formed of,” or the like is used with respect to one or more elements, one or more other elements may be added unless a term such as “only” or the like is used. The terms used in the present disclosure are merely used in order to describe example embodiments, and are not intended to limit the scope of the present disclosure. The terms of a singular form may include plural forms unless the context clearly indicates otherwise.

In construing an element, the element is construed as including an error region although there is no explicit description thereof.

In describing a positional relationship, for example, when the positional order is described as “on,” “above,” “below,” “beneath,” and “next,” the case of no contact therebetween may be included, unless “just” or “direct” is used.

If it is mentioned that a first element is positioned “on” a second element, it does not mean that the first element is essentially positioned above the second element in the figure. The upper part and the lower part of an object concerned may be changed depending on the orientation of the object. Consequently, the case in which a first element is positioned “on” a second element includes the case in which the first element is positioned “below” the second element as well as the case in which the first element is positioned “above” the second element in the figure or in an actual configuration.

In describing a temporal relationship, for example, when the temporal order is described as “after,” “subsequent,” “next,” and “before,” a case which is not continuous may be included, unless “just” or “direct” is used.

It will be understood that, although the terms “first,” “second,” etc., may be used herein to describe various elements, these elements should not be limited by these terms. These terms are only used to distinguish one element from another. For example, a first element could be termed a second element, and, similarly, a second element could be termed a first element.

In describing elements of the present disclosure, the terms “first,” “second,” “A,” “B,” “(a),” “(b),” or the like may be used. These terms are intended to identify the corresponding element(s) from the other element(s), and these are not used to define the essence, basis, order, or number of the elements.

For the expression that an element is “connected,” “coupled,” “attached,” “adhered,” or the like to another element, the element may not only be directly connected, coupled, attached, adhered, or the like to another element, but also be indirectly connected, coupled, attached, adhered, or the like to another element with one or more intervening elements disposed or interposed between the elements, unless otherwise specified.

For example, the phrase “A is connected to B” encompasses both a direct connection—where no intervening components or elements are present—and an indirect connection, where one or more intermediate components or elements exist between A and B. In other words, “A is connected to B” includes both direct physical or electrical coupling and indirect coupling through one or more intervening components. Unless explicitly stated otherwise, these terms do not require direct physical or electrical contact. The term “coupled” and other terms listed above should be interpreted in the same manner.

For the expression that an element is “contacts,” “overlaps,” or the like with another element, the element may not only directly contact, overlap, or the like with another element, but also indirectly contact, overlap, or the like with another element with one or more intervening elements disposed or interposed between the elements, unless otherwise specified.

The term “at least one” should be understood as including any and all combinations of one or more of the associated listed items. For example, “at least one among a first element, a second element and a third element” may include all combinations of two or more elements selected from the first, second and third elements as well as each element of the first, second and third elements.

Features of various embodiments of the present disclosure may be partially or entirety coupled to or combined with each other, may be technically associated with each other, and may be variously inter-operated, linked or driven together. The embodiments of the present disclosure may be implemented or carried out independently of each other, or may be implemented or carried out together in a co-dependent or related relationship. In one or more aspects, the components of each apparatus according to various embodiments of the present disclosure are operatively coupled and configured.

With respect to reference numerals to elements of each of the drawings, the same elements may be illustrated in other drawings, and like reference numerals may refer to like elements unless stated otherwise. The same or similar elements may be denoted by the same reference numerals even though they are depicted in different drawings. In addition, for convenience of description, a scale, dimension, size, and thickness of each of the elements illustrated in the accompanying drawings may be different from an actual scale, dimension, size, and thickness, and thus, embodiments of the present disclosure are not limited to a scale, dimension, size, and thickness illustrated in the drawings.

The present disclosure describes a pixel-level PWM driving circuit for a light-emitting display, particularly a micro-LED display, designed to reduce the complexity typically associated with PWM control circuits. A control node is established based on both a data voltage and a slope voltage, with the slope voltage coupled through a capacitor so that the control-node voltage changes over time during the emission period. This time-varying control-node voltage drives a control transistor that determines the light-emission interval, while a separate driving transistor supplies current to the light-emitting device. Grayscale can therefore be expressed through emission time modulation within each pixel rather than through current amplitude modulation.

The circuit structure includes a control-node circuit unit, a PWM circuit unit, and a driving circuit unit operating together with coupling capacitors and coordinated scan and emission signals. During operation, the slope voltage gradually alters the control-node voltage after the data voltage is written, and the resulting voltage transition determines when the control transistor switches to enable current flow through the light-emitting device. The driving circuit unit includes a coupling capacitor and switching transistor arrangement that allows threshold characteristics of the driving transistor to be reflected in the gate node, helping maintain consistent current delivery while emission time is controlled through the PWM path.

In another embodiment, the pixel circuit includes a photosensitive luminance control unit integrated into each subpixel. This photosensitive device forms a light-dependent leakage path within the PWM control path, enabling ambient light intensity to modify the voltage conditions that determine the control transistor’s switching timing and thus adjust emission duration in real time without a separate external sensing circuit. The photosensitive device may include an active layer exposed to front and/or rear incident light, along with non-overlapping upper and lower gate electrodes, allowing the device to detect light from one or both sides and to tune relative front- and rear-light sensitivity through gate-width ratios.

In the following description, various example embodiments of the present disclosure are described in detail with reference to the accompanying drawings.

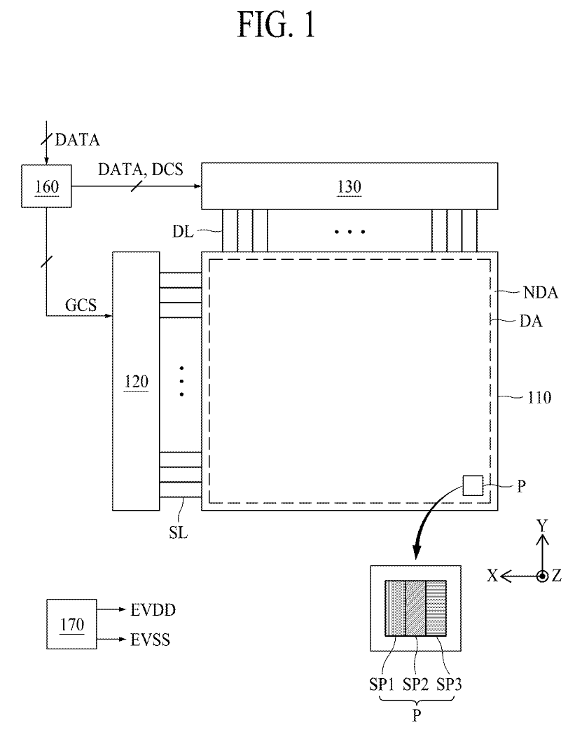

FIG. 1 illustrates a light emitting display apparatus according to an embodiment of the present disclosure.

Hereinafter, an X axis represents a direction parallel to a scan line (or a gate line), a Y axis represents a direction parallel to a data line, and a Z axis represents a height direction of a light emitting display apparatus.

The light emitting display apparatus according to an embodiment of the present disclosure may be a micro light emitting diode display apparatus. For example, the light emitting display apparatus may also be implemented as an organic light emitting display, a liquid crystal display, a quantum dot light emitting display, or an electrophoresis display, but embodiments of the present disclosure are not limited thereto.

Referring to FIG. 1, the light emitting display apparatus according to an embodiment of the present disclosure may include a display panel 110, a scan driver 120 (or a gate driver), a data driver 130, a timing controller 160, and a power circuit 170.

The display panel 110 may include a display area DA and a non-display area NDA disposed at an outer portion surrounding the display area DA. The display panel 110 may display an image by pixels P provided in the display area DA. Each of the pixels P may include a plurality of subpixels SP1, SP2, and SP3. Each pixel P may include the plurality of subpixels SP1, SP2, and SP3 formed of three micro light emitting diodes respectively emitting red, green, and blue monochromatic light.

A plurality of data lines DL and a plurality of scan lines SL (or gate lines) may be disposed in the display area DA of the display panel 110. The data lines DL and the scan lines SL may be disposed to intersect each other. The plurality of subpixels SP1, SP2, and SP3 may be disposed in regions where the data lines DL and the scan lines SL intersect each other.

Each of the subpixels SP1, SP2, and SP3 may be connected to the data lines DL and the scan lines SL and may emit light by driving signals supplied from the scan driver 120 and the data driver 130. For example, each of the subpixels SP1, SP2, and SP3 may be a micro light emitting diode having a size of 10 to 100 μm. The micro light emitting diode may be formed by repeatedly growing thin films of an inorganic material on a sapphire substrate or a silicon substrate and then separating the sapphire substrate or the silicon substrate by a shear process.

The scan driver 120 may receive a scan control signal GCS from the timing controller 160. The scan driver 120 may supply scan signals or an emission control signal to the scan lines SL by using the scan control signal GCS. For example, the scan driver 120 may be fabricated as a driving chip, mounted on a flexible film, and attached to a non-display area NDA outside one side or both sides of the display area DA by a tape automated bonding TAB method.

The data driver 130 may receive digital video data DATA and a data control signal DCS from the timing controller 160. The data driver 130 may convert the digital video data DATA into analog positive polarity or negative polarity data voltages by using the data control signal DCS and supply the analog positive polarity or negative polarity data voltages to the data lines DL.

The timing controller 160 receives digital video data DATA and timing signals from a host system. The timing signals may include a vertical synchronization signal, a horizontal synchronization signal, a data enable signal, a dot clock, and the like. The vertical synchronization signal is a signal defining one frame period. The horizontal synchronization signal is a signal defining one horizontal period required for supplying the data voltages to the pixels of one horizontal line of the display panel 110. The data enable signal defines a period in which valid data is input. The dot clock is a signal repeated at a predetermined short period.

The timing controller 160 may generate the data control signal DCS for controlling an operation timing of the data driver 130 and the scan control signal GCS for controlling an operation timing of the scan driver 120 based on the timing signals. The timing controller 160 may output the scan control signal GCS to the scan driver 120 and output the digital video data DATA and data control signal DCS to the data driver 130.

The power circuit 170 may generate and supply a plurality of driving voltages required for an operation of all circuit configurations of the display apparatus by using an input voltage. The power circuit 170 may generate a high potential driving voltage EVDD (or a first driving voltage), a low potential driving voltage EVSS (or a second driving voltage), and an initialization voltage (or a reference voltage) and supply the generated voltages to the display panel 110. The power circuit 170 may generate and supply various driving voltages required for operations of the gate driver 120, the data driver 130, and the timing controller 160.

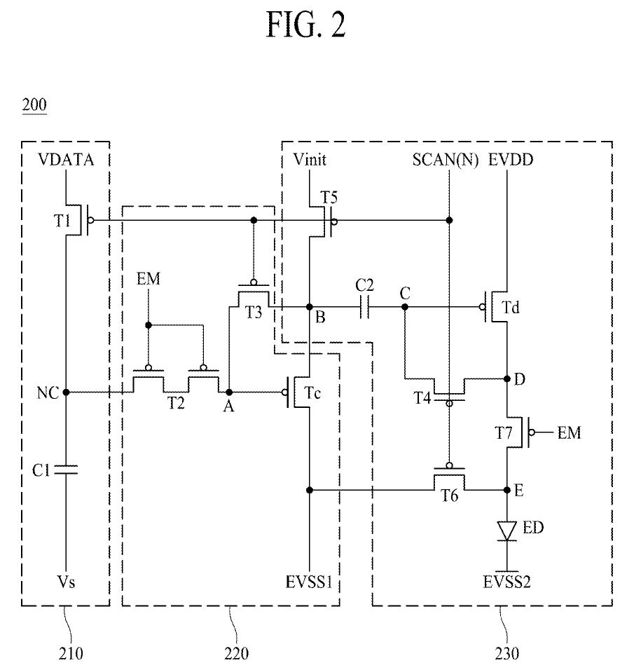

FIG. 2 is a circuit diagram illustrating a pixel driving circuit of a light emitting display apparatus according to an embodiment of the present disclosure.

Referring to FIG. 2, each pixel P may include a plurality of subpixels SP1, SP2, and SP3 constituting a unit pixel, and each of the subpixels SP1, SP2, and SP3 may include a light emitting device ED and a pixel driving circuit 200 for driving the light emitting device ED. For example, the light emitting device ED may include a micro light emitting diode. The pixel driving circuit 200 may maintain a current applied to the light emitting device ED at a fixed current value and may be implemented in a PWM (Pulse Width Modulation) method that expresses grayscale by adjusting a light emission time.

The pixel driving circuit 200 according to an embodiment of the present disclosure may include at least two coupling capacitors and a plurality of P type transistors. For example, the pixel driving circuit 200 may be configured in a 9T2C structure including nine transistors and two capacitors. As another example, the pixel driving circuit 200 may be configured in an 11T2C structure including eleven transistors and two capacitors, but embodiments of the present disclosure are not limited thereto.

The pixel driving circuit 200 may include a control node circuit unit 210, a PWM circuit unit 220, and a driving circuit unit 230.

The control node circuit unit 210 may include a control node NC having a voltage that is set based on a data voltage VDATA and a slope voltage Vs. The control node circuit unit 210 may include a first transistor T1 and a first coupling capacitor C1. The control node NC may be disposed between the first transistor T1 and the first coupling capacitor C1.

The first transistor T1 may be connected between an input terminal of the data voltage VDATA and the control node NC. The first transistor T1 may be turned on by a scan signal SCAN to supply the data voltage VDATA to the control node NC.

The first coupling capacitor C1 may be connected between an input terminal of the slope voltage Vs and the control node NC. The first coupling capacitor C1 may supply the slope voltage Vs to the control node NC through a coupling effect. For example, the slope voltage Vs may be an analog voltage signal having a slope, and the first coupling capacitor C1 may transfer a variation of the slope voltage Vs to the control node NC to gradually change or stabilize a voltage of the control node NC. The slope of the slope voltage Vs may be based on a swing width of the data voltage VDATA. The swing width of the data voltage VDATA may be a range between a maximum value and a minimum value of the data voltage VDATA expressing grayscale of the light emitting device. In addition, the slope voltage Vs may be maintained at a constant high voltage while the first transistor T1 is turned on and may decrease with a constant slope when the first transistor T1 is turned off.

The control node NC may have a voltage level that is set based on the data voltage VDATA transmitted through the first transistor T1 and the slope voltage Vs transmitted through the first coupling capacitor C1. The voltage level of the control node NC may be supplied to the PWM circuit unit 220 and may be used to control a light emission time of the light emitting device.

The PWM circuit unit 220 may include a control transistor Tc that adjusts a light emission time of the light emitting device ED according to a voltage of the control node NC. The PWM circuit unit 220 may further include one or more transistors connected to the control transistor Tc. The PWM circuit unit 220 may include a second transistor T2 connected between the control node NC and a gate electrode of the control transistor Tc. In addition, the PWM circuit unit 220 may include a third transistor T3 connected between an A node A between the control transistor Tc and the second transistor T2 and a B node B of the driving circuit unit 230. The control transistor Tc may be connected between the B node B and an input terminal of the first low potential driving voltage EVSS1.

The second transistor T2 may be connected between the control node NC and the A node A. The second transistor T2 may be turned on by an emission signal EM different from the scan signal SCAN to transmit a voltage of the control node NC to the A node A. For example, the scan signal SCAN and the emission signal EM may be opposite signals. For example, when the scan signal SCAN has a high voltage, the emission signal EM may have a low voltage and may turn on the second transistor T2. For example, the second transistor T2 may be configured as a dual transistor.

The third transistor T3 may be connected between the A node A and the B node B of the driving circuit unit 230. For example, the B node B may be an input node through which the voltage of the control node NC is applied to the driving circuit unit 230. The third transistor T3 may be turned on by the scan signal SCAN to electrically connect the A node A and the B node B.

The control transistor Tc may have a gate electrode connected to the A node A, a source electrode connected to the B node B, and a drain electrode connected to an input terminal of the first low potential driving voltage EVSS1. The control transistor Tc may be turned on according to the voltage of the control node NC to supply the first low potential driving voltage EVSS1 to the driving circuit unit 230. The control transistor Tc may be turned on or turned off according to the voltage of the control node NC to supply or block the first low potential driving voltage EVSS1 to the driving circuit unit 230, thereby controlling a flow of a driving current supplied to the light emitting device ED through the driving circuit unit 230. Accordingly, the control transistor Tc may adjust a light emission time of the light emitting device ED.

The driving circuit unit 230 may include a driving transistor Td controlled by the PWM circuit unit 220 to control a current flowing through the light emitting device ED. For example, the driving transistor Td may be turned on according to a voltage supplied through the control transistor Tc to control the current flowing through the light emitting device ED. The driving circuit unit 230 may further include one or more transistors and a coupling capacitor connected to the driving transistor Td. The driving circuit unit 230 may include a second coupling capacitor C2 connected between the B node B and a C node C which is a gate node of the driving transistor Td. In addition, the driving circuit unit 230 may include a fourth transistor T4 connected between the C node C and a D node D which is a drain node of the driving transistor Td. The driving transistor Td may be connected between an input terminal of the high potential driving voltage EVDD and the light emitting device ED.

The second coupling capacitor C2 may be connected between the B node B and the C node C. The second coupling capacitor C2 may supply a voltage supplied from the PWM circuit unit 220 to the C node C through a coupling effect.

The fourth transistor T4 may be connected between the C node C and the D node D. The fourth transistor T4 may be turned on by the scan signal SCAN to electrically connect the C node C and the D node D. For example, the fourth transistor T4 may compensate for a threshold voltage of the driving transistor Td by reflecting the threshold voltage of the driving transistor Td to the C node C.

The driving circuit unit 230 may further include a plurality of transistors T5, T6, and T7 for initialization of the driving circuit unit 230 and driving of the light emitting device ED. The driving circuit unit 230 may include a fifth transistor T5, a sixth transistor T6, and a seventh transistor T7.

The fifth transistor T5 may be connected between the B node B and an input terminal of an initialization voltage Vinit. The fifth transistor T5 may be turned on by the scan signal SCAN to supply the initialization voltage Vinit to the B node B. The fifth transistor T5 may initialize the B node B with the initialization voltage Vinit.

The sixth transistor T6 may be connected between an input terminal of the first low potential driving voltage EVSS1 and an E node E connected to one end of the light emitting device ED. The sixth transistor T6 may be turned on by the scan signal SCAN to supply the first low potential driving voltage EVSS1 to the E node E. The sixth transistor T6 may initialize the E node E with the first low potential driving voltage EVSS1.

The seventh transistor T7 may be connected between the D node D and the E node E. The seventh transistor T7 may be turned on by the emission signal EM to electrically connect the D node D and the E node E.

The light emitting device ED may be connected between the E node E and an input terminal of the second low potential driving voltage EVSS2. The second low potential driving voltage EVSS2 may be the same as or different from the first low potential driving voltage EVSS1. For example, the first low potential driving voltage EVSS1 may be lower than the second low potential driving voltage EVSS2, but embodiments of the present disclosure are not limited thereto.

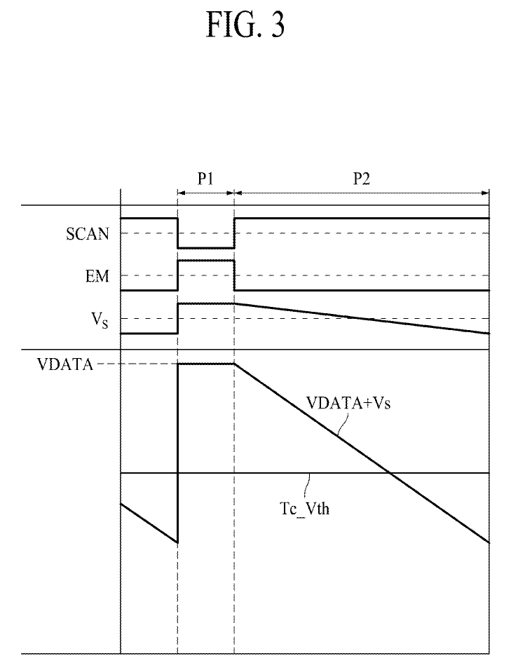

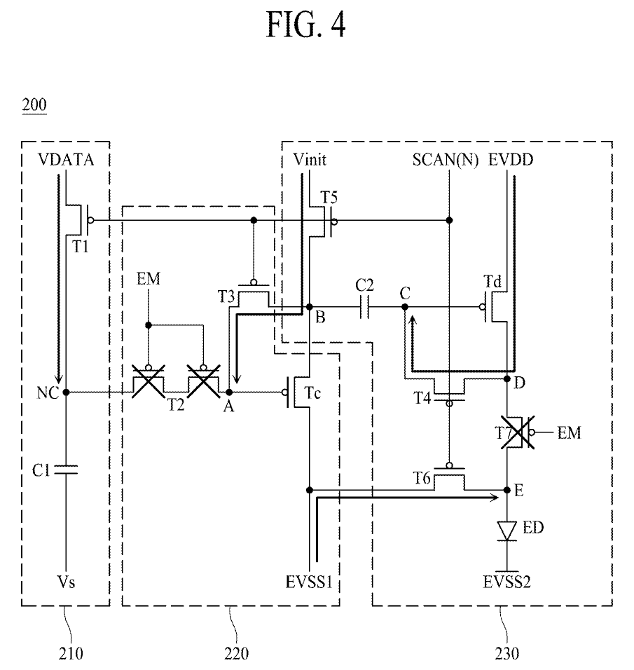

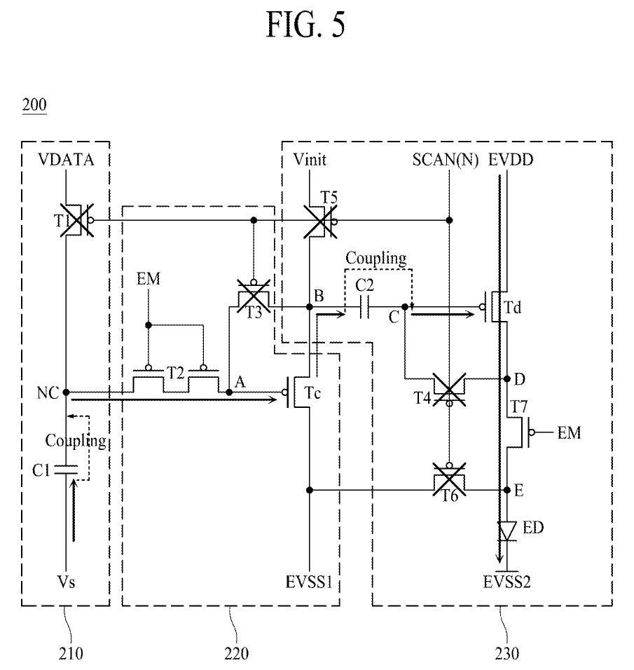

FIG. 3 illustrates driving timing of a pixel driving circuit according to an embodiment of the present disclosure. FIG. 4 illustrates an operation state of the pixel driving circuit in a first period shown in FIG. 3 according to an embodiment of the present disclosure. FIG. 5 illustrates an operation state of the pixel driving circuit in a second period shown in FIG. 3 according to an embodiment of the present disclosure.

Referring to FIGS. 3 to 5, the pixel driving circuit 200 according to an embodiment of the present disclosure may be driven according to a first period P1 and a second period P2.

The pixel driving circuit 200 may receive driving voltages such as the high potential driving voltage EVDD, the first low potential driving voltage EVSS1, the second low potential driving voltage EVSS2, the data voltage VDATA, the initialization voltage Vinit, and the slope voltage Vs, and control signals such as the scan signal SCAN and the emission signal EM.

The scan signal SCAN may be a signal for controlling the first transistor T1, the third transistor T3, the fourth transistor T4, the fifth transistor T5, and the sixth transistor T6. The emission signal EM may be a signal for controlling the second transistor T2 and the seventh transistor T7. The scan signal SCAN and the emission signal EM may be supplied from the scan driver 120. For example, the scan signal SCAN and the emission signal EM may have a gate on voltage or a gate off voltage maintained for a predetermined period of time. For example, the gate on voltage may be a low voltage that turns on a transistor, and the gate off voltage may be a high voltage that turns off the transistor. The scan signal SCAN and the emission signal EM may have different timings. For example, the scan signal SCAN and the emission signal EM may be opposite signals.

The data voltage VDATA may be a voltage supplied to a gate electrode of the driving transistor Td to cause the light emitting device ED to emit light with a predetermined luminance, and may have a voltage value that varies to express grayscale of the light emitting device ED. The data voltage VDATA may vary within a range between a minimum value and a maximum value for expressing grayscale of the light emitting device ED.

The slope voltage Vs may be an analog voltage signal having a slope, and the slope of the slope voltage Vs may be based on a swing width of the data voltage VDATA. The slope voltage Vs may be maintained at a constant high voltage while the scan signal SCAN is at a gate on voltage, and may decrease with a constant slope while the scan signal SCAN is at a gate off voltage.

The first period P1 may be an initialization period for initializing the pixel driving circuit 200. In the first period P1, the scan signal SCAN may have a gate on voltage, and the emission signal EM may have a gate off voltage. For example, the scan signal SCAN may have a low voltage level during the first period P1, and the emission signal EM may have a high voltage level during the first period P1. In addition, the slope voltage Vs may be maintained at a constant high voltage during the first period P1.

The second period P2 may be an emission period for causing the light emitting device ED to emit light. In the second period P2, the scan signal SCAN may have a gate off voltage, and the emission signal EM may have a gate on voltage. For example, the scan signal SCAN may have a high voltage level during the second period P2, and the emission signal EM may have a low voltage level during the second period P2. In addition, the slope voltage Vs may be a voltage that decreases with a constant slope during the second period P2.

Referring to FIGS. 3 and 4, in the first period P1, the first transistor T1, the third transistor T3, the fourth transistor T4, the fifth transistor T5, and the sixth transistor T6 may be turned on by the scan signal SCAN applied with a gate on voltage, and the second transistor T2 and the seventh transistor T7 may be turned off by the emission signal EM applied with a gate off voltage. In addition, in the first period P1, the data voltage VDATA and the slope voltage Vs may be applied as voltages having the same voltage level.

During the first period P1, the control node NC of the control node circuit unit 210 may be initialized by the data voltage VDATA and the slope voltage Vs. For example, the first coupling capacitor C1 may be initialized by the data voltage VDATA and the slope voltage Vs supplied at the same voltage level.

During the first period P1, the A node A of the PWM circuit unit 220 may be initialized by the initialization voltage Vinit. For example, the A node A may be electrically floating as the second transistor T2 and the control transistor Tc are turned off, and may be initialized by the initialization voltage Vinit supplied through the third transistor T3 and the fifth transistor T5 that are turned on.

During the first period P1, the B node B of the driving circuit unit 230 may be initialized by the initialization voltage Vinit supplied through the fifth transistor T5 that is turned on, and the C node C of the driving circuit unit 230 may store a threshold voltage of the driving transistor Td reflected thereto as the fourth transistor T4 is turned on. In addition, the E node E may be initialized by the first low potential driving voltage EVSS1 supplied through the sixth transistor T6.

Referring to FIGS. 3 and 5, in the second period P2, the first transistor T1, the third transistor T3, the fourth transistor T4, the fifth transistor T5, and the sixth transistor T6 may be turned off by the scan signal SCAN applied while switching from a gate on voltage to a gate off voltage, and the second transistor T2 and the seventh transistor T7 may be turned on by the emission signal EM applied while switching from a gate off voltage to a gate on voltage. In addition, in the second period P2, the slope voltage Vs may be applied as a voltage decreasing with a constant slope, and the first coupling capacitor C1 may transfer a variation of the slope voltage Vs to the control node NC so that the data voltage VDATA at the control node NC may gradually change.

During the second period P2, the control node NC of the control node circuit unit 210 may have a voltage level in which the data voltage VDATA gradually changes according to the slope of the slope voltage Vs.

During the second period P2, the second transistor T2 of the PWM circuit unit 220 may be turned on to transfer the voltage of the control node NC to the gate electrode of the control transistor Tc, and the control transistor Tc may be turned on or turned off according to the voltage of the control node NC to control a light emission time of the light emitting device ED. For example, the control transistor Tc may be turned on or turned off according to the voltage of the control node NC to supply or block the first low potential driving voltage EVSS1 to the B node B.

During the second period P2, the second coupling capacitor C2 of the driving circuit unit 230 may supply the first low potential driving voltage EVSS1 transmitted through the control transistor Tc to the C node C through a coupling effect. The driving transistor Td may be turned on by the voltage of the C node C reflecting a threshold voltage of the driving transistor Td to control a driving current flowing through the light emitting device ED. The seventh transistor T7 may be turned on during the second period P2 to transfer the driving current generated by the driving transistor Td to the light emitting device ED. The light emitting device ED may emit light by the supplied driving current.

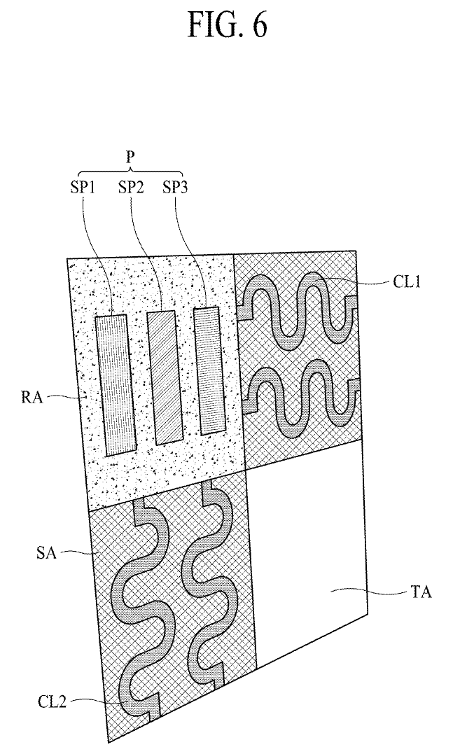

FIG. 6 illustrates a pixel structure of a light emitting display apparatus according to another embodiment of the present disclosure.

Referring to FIG. 6, the light emitting display apparatus according to another embodiment of the present disclosure may be a stretchable display apparatus capable of displaying an image even when bent or stretched. For example, the light emitting display apparatus may have not only flexible characteristics but also stretchable characteristics, so that a user may bend or stretch the light emitting display apparatus, and a shape of the light emitting display apparatus may be freely changed according to a manipulation of the user. For example, when a user holds and pulls an end of the light emitting display apparatus, the light emitting display apparatus may be stretched in a direction in which the user pulls. Alternatively, when the light emitting display apparatus is disposed on a non-flat outer surface by a user, the light emitting display apparatus may be disposed to be bent according to a shape of the outer surface. In addition, when an external force applied by the user is removed, the light emitting display apparatus may be restored to an original shape.

Referring to FIG. 6, the light emitting display apparatus according to another embodiment of the present disclosure may include a rigid area RA in which pixels P including a plurality of subpixels SP1, SP2, and SP3 are disposed, a soft area SA in which connection lines CL connecting the pixels P are disposed, and a transmission area TA disposed between the rigid area RA and the soft area SA.

The rigid area RA may have a plurality of subpixels SP1, SP2, and SP3 disposed therein, and each of the subpixels SP1, SP2, and SP3 may include a light emitting device ED which is a display device and a pixel driving circuit 200 for driving the light emitting device ED. For example, the plurality of subpixels SP1, SP2, and SP3 may be configured with three micro light emitting diodes that respectively emit red, green, and blue monochromatic light, but embodiments of the present disclosure are not limited thereto. The rigid area RA may include a plurality of rigid areas RA spaced apart from each other in a first direction (or X axis direction) and a second direction (or Y axis direction).

The soft area SA may be disposed between adjacent rigid areas RA. The soft area SA may include a first soft area SA1 in which a first connection line CL1 connecting pixels P disposed in rigid areas RA adjacent in the first direction is disposed, and a second soft area SA2 in which a second connection line CL2 connecting pixels P disposed in rigid areas RA adjacent in the second direction is disposed. The soft area SA may be a portion that may be stretched or bent by an external force and may be formed of a material having greater flexibility than that of the rigid area RA.

The transmission area TA may be an area excluding the rigid area RA and the soft area SA. The transmission area TA may be disposed between the first soft area SA1 disposed in the first direction and the second soft area SA2 disposed in the second direction with respect to the rigid area RA. For example, the transmission area TA may be surrounded by adjacent rigid areas RA and soft areas SA. The transmission area TA may allow external light to pass therethrough. For example, the transmission area TA may allow external light incident from a front surface of the light emitting display apparatus to pass to a rear surface of the light emitting display apparatus, or may allow external light incident from the rear surface of the light emitting display apparatus to pass to the front surface of the light emitting display apparatus. The transmission area TA may be a portion that may be stretched or bent by an external force and may be formed of a material having greater flexibility than that of the rigid area RA.

The light emitting display apparatus according to another embodiment of the present disclosure, when stretched or bent by an external force, may have an increased distance between pixels P disposed in the rigid area RA, and an amount of external light passing through the transmission area TA may vary as an area of the transmission area TA increases. Accordingly, overall luminance uniformity and visibility of the light emitting display apparatus may be deteriorated. Accordingly, the light emitting display apparatus according to another embodiment of the present disclosure may further include a luminance control unit capable of controlling luminance of each subpixel in real time in response to a variation of external light.

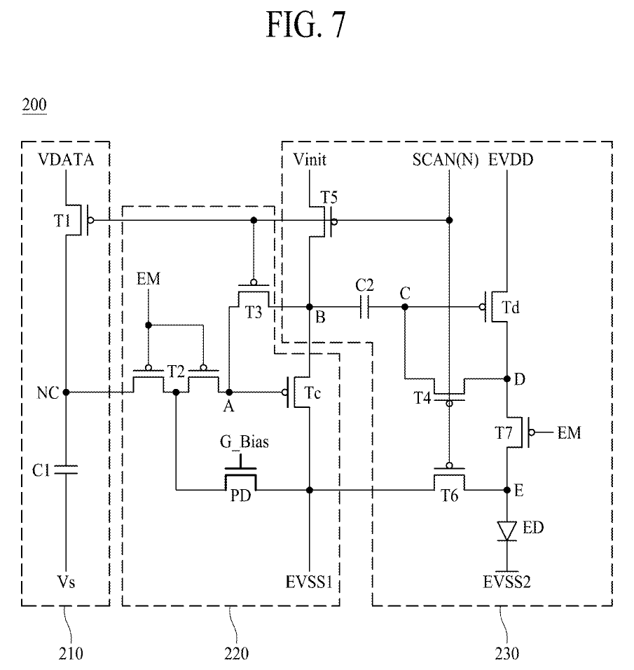

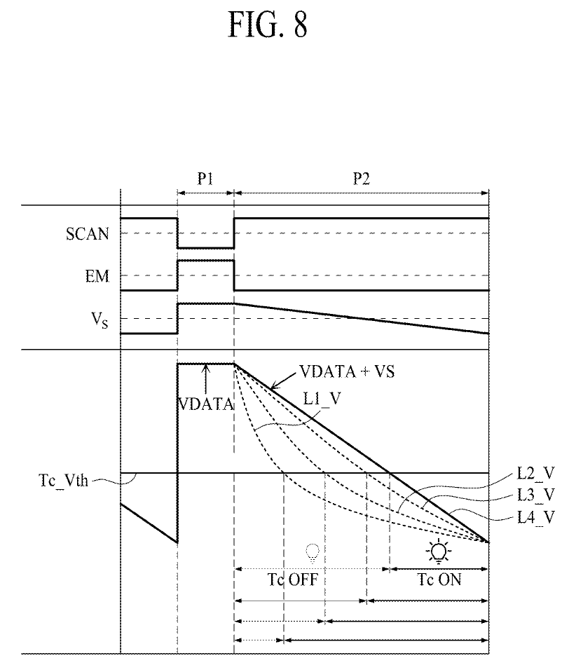

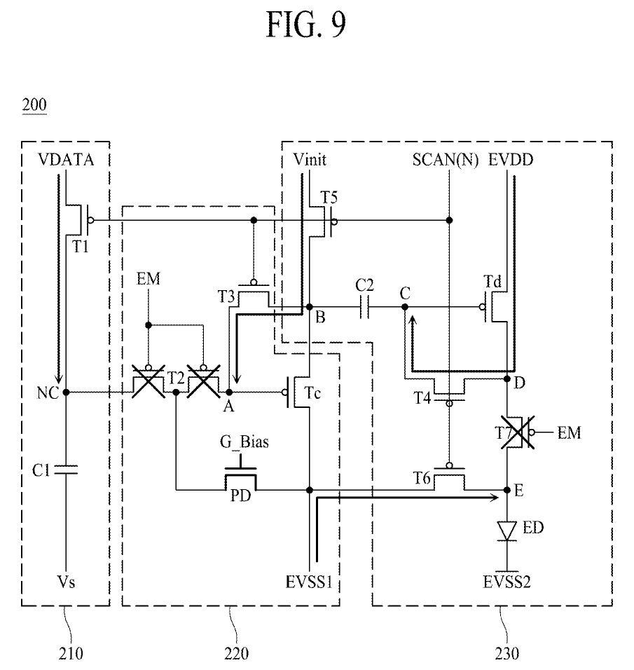

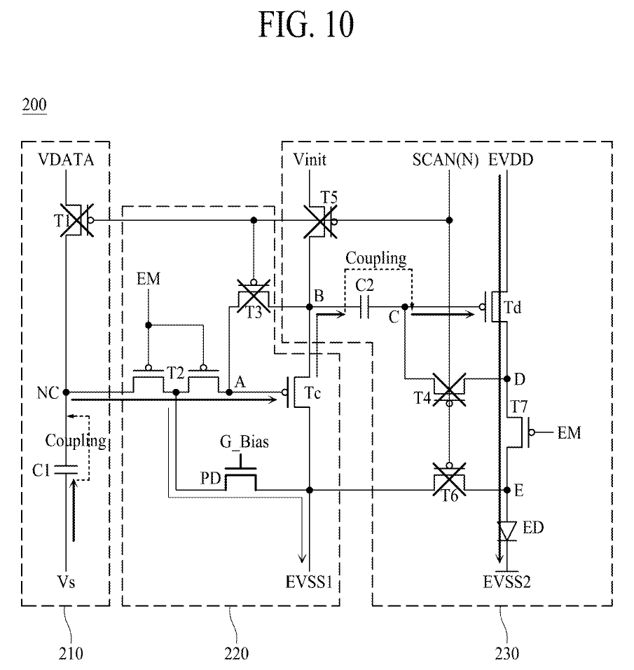

FIG. 7 is a circuit diagram illustrating a pixel driving circuit of a light emitting display apparatus according to another embodiment of the present disclosure. FIG. 8 illustrates driving timing of a pixel driving circuit according to another embodiment of the present disclosure. FIG. 9 illustrates an operation state of the pixel driving circuit in a first period shown in FIG. 8 according to another embodiment of the present disclosure. FIG. 10 illustrates an operation state of the pixel driving circuit in a second period shown in FIG. 8 according to another embodiment of the present disclosure. FIGS. 7 to 10 illustrate another embodiment in which a luminance control unit is added to the pixel driving circuit of the light emitting display apparatus described with reference to FIGS. 1 to 5. In the following description with reference to FIGS. 7 to 10, the same reference numerals are used for the same components except for the added luminance control unit, and repeated descriptions are omitted or briefly described.

Referring to FIG. 7, the pixel driving circuit 200 according to another embodiment of the present disclosure may further include a luminance control unit PD. The luminance control unit PD may be configured to control luminance of each subpixel in real time in response to a variation of external light.

The luminance control unit PD may be a photosensitive device that changes a voltage of the control node NC according to an intensity of external light. For example, the photosensitive device may be a phototransistor or a photodiode capable of sensing an intensity of external light and adjusting a magnitude of a voltage or an amount of current according to the sensed intensity of the external light.

The luminance control unit PD may be disposed in the PWM circuit unit 220. The luminance control unit PD may be connected between a common node of the dual transistor constituting the second transistor T2 and an input terminal of the first low potential driving voltage EVSS1. The luminance control unit PD may provide a leakage path between the common node of the second transistor T2 and the input terminal of the first low potential driving voltage EVSS1. For example, the luminance control unit PD may bypass a voltage or a current applied from the control node NC of the control node circuit unit 210 to the input terminal of the first low potential driving voltage EVSS1. The luminance control unit PD may control a magnitude of the voltage or current bypassed according to an intensity of external light. For example, the photosensitive device of the luminance control unit PD may sense external light applied to at least one of a front surface and a rear surface of the light emitting display apparatus.

The luminance control unit PD may have a gate electrode connected to an input terminal of a gate bias voltage G_Bias, a source electrode connected to the common node of the second transistor T2, and a drain electrode connected to an input terminal of the first low potential driving voltage EVSS1. The luminance control unit PD may be turned on when an intensity of external light is greater than or equal to a predetermined level to electrically connect the common node of the second transistor T2 and the input terminal of the first low potential driving voltage EVSS1. In addition, the luminance control unit PD may control a magnitude of a voltage or current bypassed from the common node of the second transistor T2 to the input terminal of the first low potential driving voltage EVSS1 according to an intensity of external light.

Referring to FIGS. 8 and 9, in the first period P1, the first transistor T1, the third transistor T3, the fourth transistor T4, the fifth transistor T5, and the sixth transistor T6 may be turned on by the scan signal SCAN applied as a gate on voltage, and the second transistor T2 and the seventh transistor T7 may be turned off by the emission signal EM applied as a gate off voltage. In addition, in the first period P1, the data voltage VDATA and the slope voltage Vs may be applied as voltages having the same voltage level.

During the first period P1, the luminance control unit PD of the PWM circuit unit 220 may be turned off because the gate bias voltage G_Bias may be applied as a gate off voltage. In addition, the luminance control unit PD may be electrically floating as the second transistor T2 and the control transistor Tc are turned off.

Referring to FIGS. 8 and 10, in the second period P2, the first transistor T1, the third transistor T3, the fourth transistor T4, the fifth transistor T5, and the sixth transistor T6 may be turned off by the scan signal SCAN applied while being switched from the gate on voltage to the gate off voltage, and the second transistor T2 and the seventh transistor T7 may be turned on by the emission signal EM applied while being switched from the gate off voltage to the gate on voltage. In addition, in the second period P2, the slope voltage Vs may be applied as a voltage decreasing with a constant slope, and the first coupling capacitor C1 may transfer a variation of the slope voltage Vs to the control node NC so that the data voltage VDATA at the control node NC may be gradually changed.

During the second period P2, the control node NC of the control node circuit unit 210 may have a voltage level in which the data voltage VDATA is gradually changed according to a slope of the slope voltage Vs.

During the second period P2, the second transistor T2 of the PWM circuit unit 220 may be turned on to transfer the voltage of the control node NC to the gate electrode of the control transistor Tc, and the control transistor Tc may be turned on or turned off according to the voltage of the control node NC to control a light emission time of the light emitting device ED. For example, the control transistor Tc may be turned on or turned off according to the voltage of the control node NC to supply or block the first low potential driving voltage EVSS1 to the B node B.

During the second period P2, the luminance control unit PD may sense an intensity of external light because the gate bias voltage G_Bias may be applied as a gate on voltage. The luminance control unit PD may sense the intensity of external light and electrically connect the common node of the second transistor T2 and the input terminal of the first low potential driving voltage EVSS1 according to the sensed intensity of the external light. For example, when the intensity of the external light is greater than or equal to a predetermined level, the luminance control unit PD may electrically connect the common node of the second transistor T2 and the input terminal of the first low potential driving voltage EVSS1. The luminance control unit PD may control a magnitude of a voltage or current bypassed from the common node of the second transistor T2 to the input terminal of the first low potential driving voltage EVSS1 according to the intensity of the external light.

Referring to FIG. 8, the luminance control unit PD may control a magnitude of a voltage or current of the common node of the second transistor T2 according to an intensity of external light. For example, the external light may be classified into first external light L1, second external light L2, third external light L3, and fourth external light L4 according to an amount of light. The first external light L1 may have a greater amount of light than the second external light L2, the second external light L2 may have a greater amount of light than the third external light L3, and the third external light L3 may have a greater amount of light than the fourth external light L4. The fourth external light L4 may correspond to a dark state. When the first external light L1 is sensed, the luminance control unit PD may quickly lower a voltage L1_V of the common node of the second transistor T2 to a level equal to or lower than a threshold voltage TC_Vth of the control transistor Tc, thereby advancing a timing at which the control transistor Tc is turned on. When the second external light L2 is sensed, the luminance control unit PD may adjust a common voltage L2_V of the second transistor T2 so that a timing at which the control transistor Tc is turned on is delayed compared with when the first external light L1 is sensed. When the third external light L3 is sensed, the luminance control unit PD may adjust a common voltage L3_V of the second transistor T2 so that the timing at which the control transistor Tc is turned on is delayed compared with when the first or second external light L1 or L2 is sensed. When the fourth external light L4 is sensed, the luminance control unit PD may block a leakage path between the common node of the second transistor T2 and the input terminal of the first low potential driving voltage EVSS1, and the timing at which the control transistor Tc is turned on may be delayed compared with when the first to third external light L1, L2, or L3 are sensed. Accordingly, the light emitting display apparatus according to another embodiment of the present disclosure may control luminance of each subpixel in real time in response to a variation of external light by the luminance control unit PD.

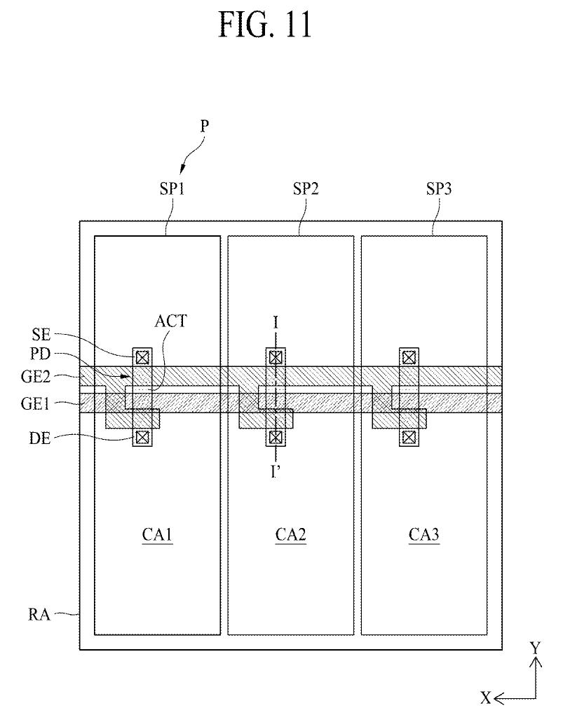

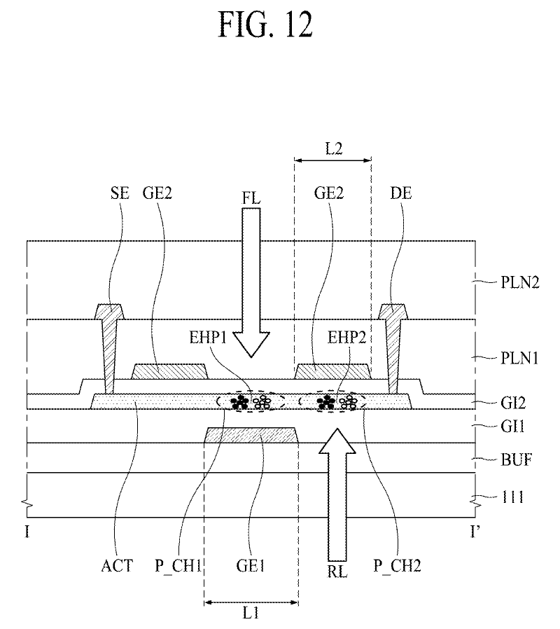

FIG. 11 illustrates a plurality of subpixels in a light emitting display apparatus according to another embodiment of the present disclosure. FIG. 12 is a cross-sectional view taken along line I-I′ of FIG. 11 according to another embodiment of the present disclosure.

Referring to FIGS. 11 and 12, the light emitting display apparatus according to another embodiment of the present disclosure may be a micro light emitting diode display apparatus, and each pixel P may include a plurality of subpixels SP1, SP2, and SP3 configured with three micro light emitting diodes that respectively emit red, green, and blue monochromatic light.

Each of the subpixels SP1, SP2, and SP3 may include a circuit area CA1, CA2, or CA3 in which the pixel driving circuit 200 for driving the light emitting device ED, which is a micro light emitting diode, is disposed. The circuit areas CA1, CA2, and CA3 may overlap the light emitting device ED.

The light emitting display apparatus according to another embodiment of the present disclosure may include the luminance control unit PD in the circuit areas CA1, CA2, and CA3 in which the pixel driving circuit 200 is disposed. For example, the luminance control unit PD may be disposed in a central portion of the circuit areas CA1, CA2, and CA3. In addition, the luminance control unit PD may be disposed in a portion of the circuit areas CA1, CA2, and CA3 that does not overlap the light emitting device ED. For example, the light emitting display apparatus may be a stretchable display apparatus, and each of the subpixels SP1, SP2, and SP3 may be disposed in the rigid area RA.

The luminance control unit PD may be a photosensitive device capable of sensing an intensity of external light for each of the subpixels SP1, SP2, and SP3 in response to a variation of external light and adjusting a magnitude of a voltage or an amount of current according to the sensed intensity of the external light.

The photosensitive device of the luminance control unit PD may sense external light applied to at least one of a front surface and a rear surface of the light emitting display apparatus. For example, the photosensitive device of the luminance control unit PD may include an active layer ACT that may be exposed in at least one direction of a front surface and a rear surface of the light emitting device ED. The active layer ACT may be exposed in at least one direction of the front surface and the rear surface of the light emitting device ED so that photosensitive channels P_CH1 and P_CH2 capable of sensing external light may be formed.

The photosensitive device of the luminance control unit PD may include at least one first gate electrode GE1 disposed under the active layer ACT, at least one second gate electrode GE2 disposed over the active layer ACT and not overlapping the at least one first gate electrode GE1, at least one source electrode SE electrically connected to the active layer ACT, and at least one drain electrode DE electrically connected to the active layer ACT.

Referring to FIG. 11, the at least one first gate electrode GE1 may extend in a first direction (or X axis direction) and may be disposed to cross the plurality of subpixels SP1, SP2, and SP3. The at least one second gate electrode GE2 may extend in the first direction in parallel with the at least one first gate electrode GE1 and may be disposed to cross the plurality of subpixels SP1, SP2, and SP3. The active layer ACT may extend in a second direction (or Y axis direction) crossing the first direction and may be disposed to overlap the at least one first gate electrode GE1 and the at least one second gate electrode GE2. The at least one source electrode SE may be connected to one side of the active layer ACT, and the at least one drain electrode DE may be connected to the other side of the active layer ACT.

At least one of the at least one first gate electrode GE1 and the at least one second gate electrode GE2 may include a plurality of portions overlapping the active layer ACT. For example, the at least one first gate electrode GE1 or the at least one second gate electrode GE2 may include a portion extending in the first direction and a portion branching in the second direction from a part of the portion extending in the first direction and extending while being bent again in the first direction.

Referring to FIG. 12, the light emitting display apparatus according to another embodiment of the present disclosure may include a substrate 111, a buffer layer BUF, at least one first gate electrode GE1, a first gate insulating layer GI1, an active layer ACT, a second gate insulating layer GI2, at least one second gate electrode GE2, a first planarization layer PLN1, at least one source electrode SE, at least one drain electrode DE, and a second planarization layer PLN2. For example, the luminance control unit PD may be formed with the at least one first gate electrode GE1, the active layer ACT, the at least one second gate electrode GE2, the at least one source electrode SE, and the at least one drain electrode DE.

The substrate 111 may be a substrate for supporting and protecting various components of the light emitting display apparatus and may be formed of a transparent insulating material. The substrate 111 may be formed of an insulating material capable of being bent or stretched as a flexible substrate. For example, the substrate 111 may include an elastomer such as silicone rubber including polydimethylsiloxane PDMS, polyurethane PU, or polytetrafluoroethylene PTFE, but embodiments of the present disclosure are not limited thereto.

The buffer layer BUF may be disposed on the substrate 111. The buffer layer BUF may prevent diffusion of impurity ions or penetration of moisture from the outside and may be formed as a single layer or a multilayer including an inorganic insulating material, but embodiments of the present disclosure are not limited thereto.

The at least one first gate electrode GE1 may be disposed on the buffer layer BUF, and the first gate insulating layer GI1 may be disposed on the buffer layer BUF to cover the at least one first gate electrode GE1. The at least one first gate electrode GE1 may be disposed under the active layer ACT.

The active layer ACT may be disposed on the first gate insulating layer GI1. The active layer ACT may include a semiconductor material based on at least one oxide semiconductor selected from IGZO indium gallium zinc oxide, IZO indium zinc oxide, IGTO indium gallium tin oxide, and IGO indium gallium oxide, but embodiments of the present disclosure are not limited thereto. In addition, the first gate insulating layer GI1 may insulate the at least one first gate electrode GE1 from the active layer ACT and may be formed as a single layer or a multilayer including an inorganic insulating material, but embodiments of the present disclosure are not limited thereto.

The second gate insulating layer GI2 may be disposed on the active layer ACT. The second gate insulating layer GI2 may be disposed on the first gate insulating layer GI1 to cover the active layer ACT.

The at least one second gate electrode GE2 may be disposed on the second gate insulating layer GI2. The second gate insulating layer GI2 may insulate the active layer ACT from the at least one second gate electrode GE2 and may be formed as a single layer or a multilayer including an inorganic insulating material, but embodiments of the present disclosure are not limited thereto. The at least one second gate electrode GE2 may be disposed over the active layer ACT without overlapping the at least one first gate electrode GE1.

The first planarization layer PLN1 may be disposed on the at least one second gate electrode GE2. The first planarization layer PLN1 may be disposed on the second gate insulating layer GI2 to cover the at least one second gate electrode GE2. The at least one source electrode SE and the at least one drain electrode DE may be electrically connected to the active layer ACT through contact holes penetrating the first planarization layer PLN1 and the second gate insulating layer GI2. The second planarization layer PLN2 may be disposed on the at least one source electrode SE and the at least one drain electrode DE. The second planarization layer PLN2 may be disposed on the first planarization layer PLN1 to cover the at least one source electrode SE and the at least one drain electrode DE. The first planarization layer PLN1 and the second planarization layer PLN2 may be formed of the same or different organic insulating materials and may include organic materials such as epoxy resin, phenolic resin, polyamide resin, or polyimide resin, but embodiments of the present disclosure are not limited thereto.

In another embodiment of the present disclosure, the at least one first gate electrode GE1 and the at least one second gate electrode GE2 may be disposed so as not to overlap each other in portions overlapping the active layer ACT, and the active layer ACT may be exposed in both directions of the light emitting display apparatus so that photosensitive channels P_CH1 and P_CH2 capable of sensing external light may be formed.

The active layer ACT may not overlap the at least one second gate electrode GE2 in an upper direction of the substrate 111 and may be exposed from the at least one second gate electrode GE2, and a first photosensitive channel P_CH1 may be formed in a portion overlapping the at least one first gate electrode GE1 in a lower direction of the substrate 111. For example, front external light FL incident from a front surface of the substrate 111 may pass through the first planarization layer PLN1, the second planarization layer PLN2, and the second gate insulating layer GI2 and may be incident on the first photosensitive channel P_CH1 of the active layer ACT. A first electron hole pair EHP1 may be generated in the first photosensitive channel P_CH1 on which the front external light FL is incident. The first electron hole pair EHP1 may increase or decrease according to the intensity of the front external light FL.

In the first photosensitive channel P_CH1, a first electron hole pair EHP1 may be generated by incidence of the front external light FL and may interact with an electric field generated by a gate bias voltage applied to the first gate electrode GE1 so that electrons and holes are separated and move between the source electrode SE and the drain electrode DE to control a current flow in the first photosensitive channel P_CH1. Accordingly, the luminance control unit PD according to another embodiment of the present disclosure may control luminance corresponding to the front external light FL in real time by adjusting a magnitude of a voltage or an amount of current through the luminance control unit PD according to a change in intensity of the front external light FL.

The active layer ACT may not overlap the at least one first gate electrode GE1 in a lower direction of the substrate 111 and may be exposed from the at least one first gate electrode GE1, and a second photosensitive channel P_CH2 may be formed in a portion overlapping the at least one second gate electrode GE2 in an upper direction of the substrate 111. For example, rear external light RL incident from a rear surface of the substrate 111 may pass through the substrate 111, the buffer layer BUF, and the first gate insulating layer GI1 and may be incident on the second photosensitive channel P_CH2 of the active layer ACT. A second electron hole pair EHP2 may be generated in the second photosensitive channel P_CH2 on which the rear external light RL is incident. The second electron hole pair EHP2 may increase or decrease according to the intensity of the rear external light RL.

In the second photosensitive channel P_CH2, a second electron hole pair EHP2 may be generated by incidence of the rear external light RL and may interact with an electric field generated by a gate bias voltage applied to the second gate electrode GE2 so that electrons and holes are separated and move between the source electrode SE and the drain electrode DE to control a current flow in the second photosensitive channel P_CH2. Accordingly, the luminance control unit PD according to another embodiment of the present disclosure may control luminance corresponding to the rear external light RL in real time by adjusting a magnitude of a voltage or an amount of current through the luminance control unit PD according to a change in intensity of the rear external light RL.

The at least one first gate electrode GE1 and the at least one second gate electrode GE2 according to another embodiment of the present disclosure may have the same width or different widths. For example, in the luminance control unit PD, a photosensitive sensitivity for the front external light FL and the rear external light RL may be selectively adjusted according to a ratio between a width L1 of the first gate electrode GE1 and a width L2 of the second gate electrode GE2.

A light emitting display apparatus according to one or more embodiments of the present disclosure will be described below.

A light emitting display apparatus according to one or more embodiments of the present disclosure may include a light emitting device, and a pixel driving circuit connected to the light emitting device and configured to drive the light emitting device. The pixel driving circuit may include a control node circuit unit including a control node having a volage that is se based on a data voltage and a slope voltage, a PWM circuit unit including a control transistor configured to adjust a light emission time of the light emitting device according to the voltage of the control node, and a driving circuit unit including a driving transistor configured to be turned on by the control transistor and to control a current flowing through the light emitting device.

According to one or more embodiments of the present disclosure, the light emitting device may include a micro light emitting diode.

According to one or more embodiments of the present disclosure, the slope voltage may be an analog voltage signal having a slope.

According to one or more embodiments of the present disclosure, the slope of the slope voltage may be based on a swing width of the data voltage, the swing width being a range between a maximum value and a minimum value of gradation expression of the light emitting device.

According to one or more embodiments of the present disclosure, the pixel driving circuit may include at least two coupling capacitors and a plurality of P type transistors.

According to one or more embodiments of the present disclosure, the pixel driving circuit may further include a photosensitive device configured to change the voltage of the control node according to an intensity of external light.

According to one or more embodiments of the present disclosure, the control node circuit unit may further include a first transistor connected between an input terminal of the data voltage and the control node, and a first coupling capacitor connected between an input terminal of the slope voltage and the control node.

According to one or more embodiments of the present disclosure, the PWM circuit unit may further include a second transistor connected between the control node and a gate electrode of the control transistor, and a third transistor connected between an A node between the control transistor and the second transistor and a B node of the driving circuit unit, and the control transistor may be connected between the B node and an input terminal of a first low potential driving voltage.

According to one or more embodiments of the present disclosure, the second transistor may be formed as a dual transistor.

According to one or more embodiments of the present disclosure, the driving circuit unit may further include a second coupling capacitor connected between the B node and a C node which is a gate node of the driving transistor, and a fourth transistor connected between the C node and a D node which is a drain node of the driving transistor, and the driving transistor maybe connected between an input terminal of a high potential driving voltage and the light emitting device.

According to one or more embodiments of the present disclosure, the driving circuit unit may further include a fifth transistor connected between the B node and an input terminal of an initialization voltage, a sixth transistor connected between an input terminal of the first low potential driving voltage and an E node connected to one end of the light emitting device, and a seventh transistor connected between the D node and the E node.

According to one or more embodiments of the present disclosure, the other end of the light emitting device may be connected to an input terminal of a second low potential driving voltage that is the same as or different from the first low potential driving voltage.

According to one or more embodiments of the present disclosure, the first low potential driving voltage may be lower than the second low potential driving voltage.

According to one or more embodiments of the present disclosure, the first transistor, the third transistor, the fourth transistor, the fifth transistor, and the sixth transistor may be controlled by the same scan signal, and the second transistor and the seventh transistor may be controlled by an emission signal different from the scan signal.

According to one or more embodiments of the present disclosure, the light emitting display apparatus may further include a luminance control unit connected between a common node of the dual transistor constituting the second transistor and an input terminal of the first low potential driving voltage.

According to one or more embodiments of the present disclosure, the luminance control unit may provide a leakage path between the common node and the input terminal of the first low potential driving voltage.

According to one or more embodiments of the present disclosure, the luminance control unit may include a photosensitive device configured to control a magnitude of the leakage path according to an intensity of external light.

According to one or more embodiments of the present disclosure, the photosensitive device may include an active layer in which a photosensitive channel exposed in at least one of a front surface and a rear surface of the light emitting device is formed.

According to one or more embodiments of the present disclosure, the photosensitive device may further include at least one first gate electrode disposed under the active layer, at least one second gate electrode disposed over the active layer and not overlapping the at least one first gate electrode, at least one source electrode electrically connected to the active layer, and at least one drain electrode electrically connected to the active layer.

According to one or more embodiments of the present disclosure, the at least one first gate electrode and the at least one second gate electrode may have a same width or different widths, and the photosensitive device may be configured such that photosensitivity of the front surface and the rear surface of the light emitting device is selectively adjusted according to a ratio of a width of the at least one first gate electrode to a width of the at least one second gate electrode.

The above-described feature, structure, and effect of the present disclosure are included in at least one embodiment of the present disclosure, but are not limited to only one embodiment. Furthermore, the feature, structure, and effect described in at least one embodiment of the present disclosure may be implemented through combination or modification of other embodiments by those skilled in the art. Therefore, content associated with the combination and modification should be construed as being within the scope of the present disclosure.

The various embodiments described above can be combined to provide further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A light emitting display apparatus comprising:
a light emitting device; and
a pixel driving circuit connected to the light emitting device and configured to drive the light emitting device,
wherein the pixel driving circuit includes:
a control node circuit unit including a control node having a voltage that is set based on a data voltage and a slope voltage;
a PWM circuit unit including a control transistor configured to adjust a light emission time of the light emitting device according to the voltage of the control node; and
a driving circuit unit including a driving transistor configured to be turned on by the control transistor and to control a current flowing through the light emitting device.

2. The light emitting display apparatus of claim 1, wherein the light emitting device includes a micro light emitting diode.

3. The light emitting display apparatus of claim 1, wherein the slope voltage is an analog voltage signal having a slope.

4. The light emitting display apparatus of claim 3, wherein the slope of the slope voltage is based on a swing width of the data voltage, the swing width being a range between a maximum value and a minimum value of gradation expression of the light emitting device.

5. The light emitting display apparatus of claim 1, wherein the pixel driving circuit includes at least two coupling capacitors and a plurality of P type transistors.

6. The light emitting display apparatus of claim 1, wherein the pixel driving circuit further includes a photosensitive device configured to change the voltage of the control node according to an intensity of external light.

7. The light emitting display apparatus of claim 1, wherein the control node circuit unit further includes:
a first transistor connected between an input terminal of the data voltage and the control node; and
a first coupling capacitor connected between an input terminal of the slope voltage and the control node.

8. The light emitting display apparatus of claim 7, wherein the PWM circuit unit further includes:
a second transistor connected between the control node and a gate electrode of the control transistor; and
a third transistor connected between an A node between the control transistor and the second transistor and a B node of the driving circuit unit, and
wherein the control transistor is connected between the B node and an input terminal of a first low potential driving voltage.

9. The light emitting display apparatus of claim 8, wherein the second transistor is formed as a dual transistor.

10. The light emitting display apparatus of claim 8, wherein the driving circuit unit further includes:
a second coupling capacitor connected between the B node and a C node which is a gate node of the driving transistor; and
a fourth transistor connected between the C node and a D node which is a drain node of the driving transistor, and
wherein the driving transistor is connected between an input terminal of a high potential driving voltage and the light emitting device.

11. The light emitting display apparatus of claim 10, wherein the driving circuit unit further includes:
a fifth transistor connected between the B node and an input terminal of an initialization voltage;
a sixth transistor connected between an input terminal of the first low potential driving voltage and an E node connected to one end of the light emitting device; and
a seventh transistor connected between the D node and the E node.

12. The light emitting display apparatus of claim 11, wherein the other end of the light emitting device is connected to an input terminal of a second low potential driving voltage that is the same as or different from the first low potential driving voltage.

13. The light emitting display apparatus of claim 12, wherein the first low potential driving voltage is lower than the second low potential driving voltage.

14. The light emitting display apparatus of claim 11, wherein the first transistor, the third transistor, the fourth transistor, the fifth transistor, and the sixth transistor are controlled by the same scan signal, and
wherein the second transistor and the seventh transistor are controlled by an emission signal different from the scan signal.

15. The light emitting display apparatus of claim 9, further comprising a luminance control unit connected between a common node of the dual transistor constituting the second transistor and an input terminal of the first low potential driving voltage.

16. The light emitting display apparatus of claim 15, wherein the luminance control unit provides a leakage path between the common node and the input terminal of the first low potential driving voltage.

17. The light emitting display apparatus of claim 16, wherein the luminance control unit includes a photosensitive device configured to control a magnitude of the leakage path according to an intensity of external light.

18. The light emitting display apparatus of claim 17, wherein the photosensitive device includes an active layer in which a photosensitive channel exposed in at least one of a front surface and a rear surface of the light emitting device is formed.

19. The light emitting display apparatus of claim 18, wherein the photosensitive device further includes:
at least one first gate electrode disposed under the active layer;
at least one second gate electrode disposed over the active layer and not overlapping the at least one first gate electrode;
at least one source electrode electrically connected to the active layer; and
at least one drain electrode electrically connected to the active layer.

20. The light emitting display apparatus of claim 19, wherein the at least one first gate electrode and the at least one second gate electrode have a same width or different widths, and
wherein the photosensitive device is configured such that photosensitivity of the front surface and the rear surface of the light emitting device is selectively adjusted according to a ratio of a width of the at least one first gate electrode to a width of the at least one second gate electrode.
